(19) United States
(12) Patent Application Publication
(10) Pub. No.: US 2017/0072834 A1
(43) Pub. Date: Mar. 16, 2017

(54) VEHICLE HEADLIGHT WITH A DEVICE FOR DETERMINING ROAD CONDITIONS AND A SYSTEM FOR MONITORING ROAD CONDITIONS

(71) Applicant: G. LUFFT MESS- UND REGELTECHNIK GMBH, Fellbach-Schmiden (DE)

(72) Inventor: Axel Schmitz-Hübsch, Remseck (DE)

(73) Assignee: G. LUFFT MESS- UND REGELTECHNIK GMBH, Fellbach-Schmiden (DE)

(21) Appl. No.: 15/123,214

(22) PCT Filed: Mar. 3, 2014
(86) PCT No.: PCT/EP2014/054075

§ 371 Date: Sep. 1, 2016

(51) Int. Cl. B60Q 1/00; G01B 11/06; G01N 21/47; B60Q 1/04; F21S 8/10

(52) U.S. Cl. CPC B60Q 1/0023; B60Q 1/04; F21S 48/13; F21S 48/1233; G01N 21/4738; G01B 11/0633; G01N 2201/0696; G01N 2201/0627

(57) ABSTRACT

A vehicle headlight comprising: a lighting unit, a reflector and a headlight glass; a device for determining road conditions, said device being provided in the interior of the vehicle headlight behind the headlight glass and comprising: an infrared transmitter configured for emitting light at predetermined wavelengths through the headlight glass onto a road surface; a detection unit configured for detecting the light emitted by the infrared transmitter and reflected by the road surface through the headlight glass; a processing unit configured for determining surface parameters of the road surface on the basis of the light detected by the detection unit.

### FIELD OF THE INVENTION

The present invention relates to a vehicle headlight as well as to a system for monitoring road conditions including a vehicle comprising the vehicle headlight.

### PRIOR ART

Allowing a determination of road conditions/roadway characteristics while the vehicle is driving has been a long known problem with vehicles. Potentially dangerous road conditions can thus be signalized to the driver in time, who will then be able to adapt his way of driving accordingly. For example, a water film on the roadway may lead to aquaplaning at excessively high speeds. Likewise, dangerous situations may occur at temperatures around the freezing point in the case of ice and water mixtures on the roadway or rain on frozen ground (freezing rain).

Frequently, mobile sensors are used, which allow a measurement of the roadway characteristics only when the vehicle does not move. In this case, the vehicle must stand still for a certain period of time, e.g. a few seconds, so that a measurement can be accomplished. Determining the roadway characteristics while the vehicle is driving remains, however, difficult with this approach. Furthermore, there are sensors that are attached to the outside of the vehicle. This may entail the problem that these sensors may get dirty, e.g. through damp snow and/or dirt or mud splashing from the roadway, while the vehicle is driving. A measurement of the roadway characteristics in connection with the roadway may thus be rendered more difficult or may even fail. Information that is so important for the driver of a vehicle under difficult weather conditions and/or roadway conditions may thus be corrupted or may not even be available, so that the driver cannot be informed of risks to a sufficient extent. Even in vehicles that drive partially autonomously, i.e. in the case of which the vehicle is not steered by the driver alone, the decisions, which are required for steering the vehicle and which are to be taken e.g. by a control unit, cannot be taken with the necessary accuracy.

Taking into account the problems in the prior art, it is the object of the present invention to develop a robust and simple alternative to the prior art, which avoids the above mentioned problems.

### DESCRIPTION OF THE INVENTION

This object is achieved by a vehicle headlight according to claim 1.

The invention provides a vehicle headlight comprising: a lighting unit, a reflector and a headlight glass; as well as a device for determining road conditions, said device being provided in the interior of the vehicle headlight behind the headlight glass and comprising: an infrared transmitter configured for emitting light at predetermined wavelengths through the headlight glass onto a road surface; a detection unit configured for detecting the light emitted by the infrared transmitter and reflected by the road surface through the headlight glass; a processing unit configured for determining surface parameters of the road surface on the basis of the light detected by the detection unit. The processing unit may be provided in the form of a computer or comprise a computer.

The device for determining road conditions is provided in the interior of the vehicle headlight. Thus, the device can be protected against soiling in the best possible way. In particular, the device can be protected against soiling that may occur while the vehicle is on the road. Furthermore, the infrared transmitter of the device is configured for emitting, through the headlight glass, light having a predetermined wavelength in a wavelength region from 780 nm to 2500 nm, e.g. form 780 nm to 1000 nm or 1500 nm. Likewise, the light reflected from the road surface is detected once more through the headlight glass. The headlight glass of a vehicle is one of the vehicle's most frequently cleaned elements, in particular in the case of headlights at the front of the vehicle. The driver of the vehicle will, for example, check the headlight glass particularly frequently, at least always before setting off. In addition, there are vehicles which have their headlight glass even cleaned automatically, e.g. when a wiper for cleaning the headlight glass is provided. It follows that, by providing the device behind the headlight glass, it can be guaranteed that the device will virtually always have free sight of the roadway.

In the interior of the vehicle headlight, the device may be attached directly to the inner side of the headlight glass.

In the interior of the vehicle headlight, the device may be replaceable.

The device may be attached directly to the inner side, i.e. behind the headlight glass. The device may be attached and fixed in position making use of a suitable fastening means. In particular, the device may also be replaceable. It is also possible to replace the device or the headlight glass along with the device as a modular unit. This also offers the possibility of retrofitting existing vehicle headlights by adding the device or by replacing the headlight glass along with the device.

In the vehicle headlight, the processing unit may be configured for determining the surface parameters of the road surface at least 100 times per second, in particular at least 400 times per second.

Due to the high surface parameter determination rate, current values of these parameters as well as a change of the parameters can be detected and evaluated as promptly as possible, i.e. practically without any delay in time that would be worth mentioning, so that the driver will be able to react. When 400 determinations per second are carried out and when the vehicle is travelling at a speed of e.g. approx. 80 km/h, a measurement and a determination will be executed every 5 cm. As a matter of principle, the determination of the surface parameters should be executed so fast that the system will be able to react in a very quick and precise manner to changes in the roadway characteristics.

In the vehicle headlight, the device may additionally comprises a pulse unit configured for pulsing the light emitted by the infrared transmitter such that the resultant pulses have a maximum duration of 500 μs, in particular a maximum duration of 100 μs, and/or no-pulse periods of maximum 500 μs, in particular of maximum 100 μs.

Due to the pulses of the pulse unit, the device can emit, effectively and with little dead time, the light required for the measurement. Furthermore, the pulsing provides a time constant, a clock, for the measurement and the subsequent determination.

In the vehicle headlight, the infrared transmitter in the device may be configured for transmitting light with at least two predetermined different wavelengths or from at least two different wavelength regions (for detecting moist/wet versus dry).

In the vehicle headlight, each of the different wavelengths emitted by the infrared transmitter may lie in the infrared region, the infrared transmitter being additionally able to emit light within a reference wavelength region for the purpose of calibration, and the reference wavelength region lying also in the infrared region.

Due to the use of wavelengths in the infrared region, overlapping with the visible light region of the headlight as well as dazzling of other road users will be avoided. One of the wavelengths, e.g. a wavelength of 1500 nm, may especially be suitable for determining ice or ice layers on the roadway. Another emitted wavelength, which is different from the first one, may be suitable for determining thin water films. A water film having a thickness of up to 1 mm on the roadway may be determined by a wavelength of 1450 nm. For thicker water films or water layers on the roadway, up to a thickness of approx. 30 mm of the water layer, a further wavelength of approx. 980 nm may be used. In addition, a further wavelength of 1300 nm may be emitted, permanently or periodically or at least when the vehicle is setting off, as a reference wavelength for the purpose of calibration. Typically, the above mentioned three wavelengths as well as the reference wavelength are different from one another. It goes without saying that also other wavelengths may be used. Quite generally, the wavelengths may be adapted to the absorption bands of water and ice.

In the vehicle headlight, the surface parameters may comprise one or a plurality of parameters for wetness, ice thickness, snow thickness, water film thickness, the ice-to-water ratio, the freezing temperature of an ice-water mixture, the salt content of an ice-water mixture and the coefficient of friction. With these parameters, the parameters most important for the driver of the vehicle are determined and can be analyzed with respect to possible risks.

In the vehicle headlight, the device may additionally comprise an interface for an exchange of data with the Internet and/or a mobile computer unit and/or a mobile radio unit. The interface may comprise e.g. a CAN interface or some other interface typical of motor vehicles. In particular, information/data acquired by the device can be transmitted to other vehicles.

The present invention additionally provides a vehicle, in particular a passenger car or a motor truck, comprising at least one vehicle headlight of the type described hereinbefore. The vehicle may comprise a wireless data connection unit configured for transmitting data to another vehicle, and a control unit configured for transmitting data acquired by means of the device for determining road conditions to said other vehicle via the data connection unit. In future, vehicles will communicate with one another and an oncoming vehicle can thus be warned about critical roadway conditions in advance. The vehicle comprising the headlight according to the present invention may e.g. be a sanding truck. The data connection unit may be provided with a transmitter and an antenna for transmitting data. The control unit may comprise a computer or a CPU.

In addition, the present invention provides a system for monitoring road conditions, comprising a vehicle of the type described hereinbefore and an internet server connected to the device for determining road conditions for the purpose of an exchange of data and a computer unit connected via the internet server to said device for the purpose of an exchange of data.

In said system, monitoring of the road conditions can be provided by a vehicle comprising at least one vehicle headlight according to the present invention.

In the following, further features and exemplary embodiments of the present invention will be explained in more detail making reference to the drawings. It should be understood that the embodiments do not exhaust the scope of the present invention. It should also be understood that some or all of the features described hereinbelow may also be combined with one another in some other way.

### SHORT DESCRIPTION OF THE FIGURES

FIG. 1: schematic sketch of a vehicle comprising a vehicle headlight according to the present invention.

FIG. 2: schematic sketch of a vehicle headlight as outlined in FIG. 1, comprising a device for determining road conditions according to the present invention.

FIG. 3: schematic sketch of the device according to FIG. 2.

FIG. 4: schematic sketch of a system for monitoring road conditions, including a vehicle.

### DETAILED DESCRIPTION

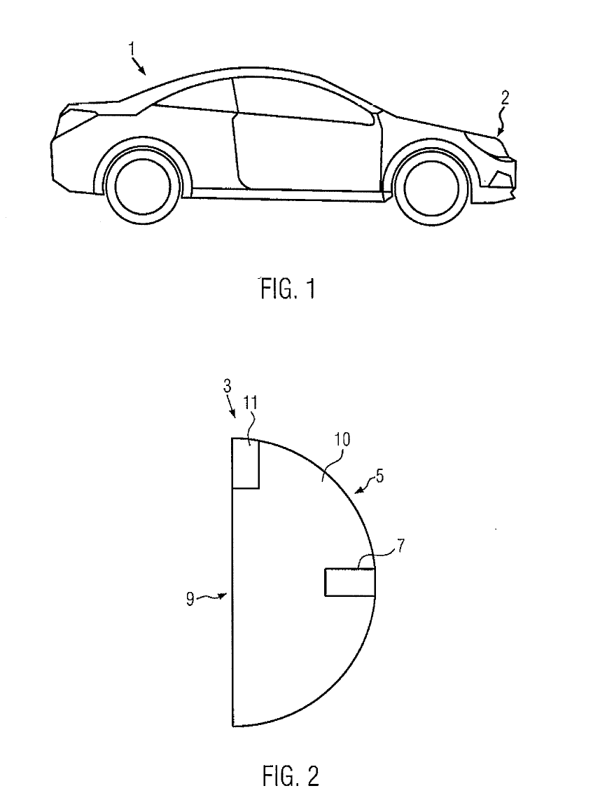

FIG. 1 shows a vehicle 1 comprising a vehicle headlight 3 according to the present invention. Only by way of example, the vehicle is sketched as a passenger car. It goes without saying that the vehicle may also be a motor truck or a motor cycle.

In the following embodiments, an LED unit is used as an infrared transmitter. This should be considered as an example and other suitable infrared transmitters may be used alternatively.

The vehicle headlight 3 is outlined in more detail in FIG. 2. The vehicle headlight 3 comprises a lighting source 7 for generating headlight. In addition, the vehicle headlight comprises a reflector 5 and a headlight glass 9. The headlight glass 9 may comprise a silicon-dioxide based glass suitable for use in the vehicle headlight 3 or it may comprise plastic such as acrylic glass or polycarbonate. Other glasses may, however, be used as well. The headlight glass 9 is transparent to the light generated by the lighting source 7. The vehicle headlight 3 additionally comprises a device 11 for determining road conditions, said device being provided in the interior of the vehicle headlight 3 behind the headlight glass 9. In FIG. 2 the device 11 is provided directly behind the headlight glass 9. This is advantageous insofar as light emitted by the device 11, which is subsequently reflected by the road surface of the road on which the vehicle 1 is travelling, has to travel the shortest possible distance for passing through the headlight glass 9, i.e. said light will enter practically directly from the device 11 into the headlight glass 9 and will then be emitted, or, in the case of light reflected by the road surface/roadway surface, it will fall directly from the headlight glass 9 onto the device 11. The device 11 may be replaceable. Also the headlight glass 9 may be replaceable. In addition or alternatively, also the headlight glass 9 along with the device 11 may be replaceable, so that various possibilities of maintenance or retrofitting may be obtained.

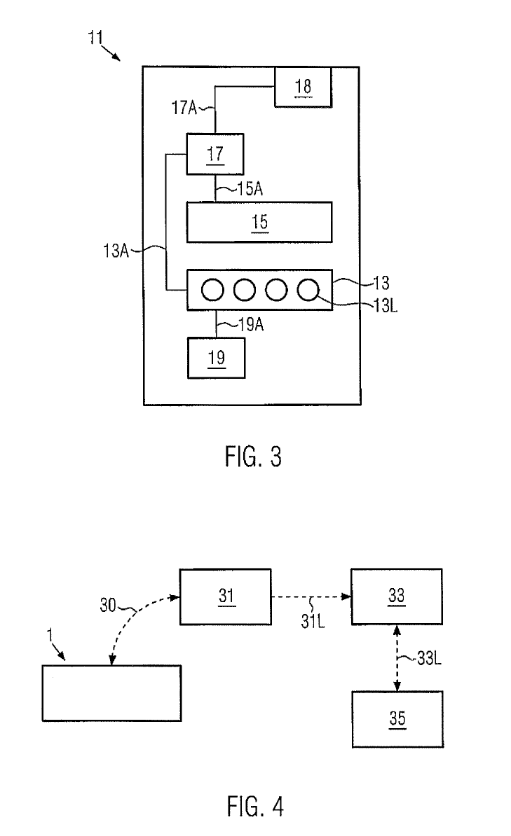

The device 11 will be explained in more detail making reference to FIG. 3. FIG. 3 sketches a front view of the device 11 according to FIG. 2. In FIG. 3 the device 11 comprises an LED unit 13. Only by way of example, the LED unit 13 shown in FIG. 3 comprises four LEDs 13L. The LED unit 13 may, however, also comprise a different number of LEDs. The number of four LEDs 13L is, however, advantageous insofar as each LED 13L may fulfil a different function. Typically, the LEDs 13L may emit light in the infrared region. In principle, also other wavelengths are possible. Light in the infrared region is, on the one hand, invisible to other road users and, on the other hand, it is particularly suitable for detecting water layers and ice layers, in particular on roadway surfaces. One of the wavelengths emitted by the LEDs 13L of the LED unit 13 may be suitable for determining ice or ice layers on the roadway, said wavelength being e.g. a wavelength of 1500 nm. A second LED 13L may emit a wavelength which differs from the first wavelength and which may be particularly suitable for determining thin water films. A water film having e.g. a thickness of up to 1 mm on the roadway may thus be determined by a wavelength of 1450 nm. For thicker water films or water layers on the roadway, up to a thickness of approx. 30 mm of the water layer, a further wavelength with a further LED may be used. This further wavelength may in particular be a wavelength of approx. 980 nm. In addition, a further wavelength of 1300 nm may be emitted by means of a fourth LED 13L permanently or periodically or at least when the vehicle is setting off. This additional wavelength may be used as a reference wavelength for the purpose of calibration. It goes without saying that also other wavelengths may be used. Likewise, also more than four LEDs may be used.

The LED unit 13 may be controlled via a pulse unit 19. The pulse unit 19 may be connected to the LED unit via a line 19A.

The LED unit 13 transmits with the aid of the LEDs 13L light through the headlight glass 9. The light emitted by the LED unit 13 in this way falls on the roadway surface where it is reflected.

FIG. 3 additionally shows a detection unit 17, e.g. a sensor unit, for detecting the light emitted by the LED unit 13 and reflected then by the road surface. This reflected light falls, in turn, through the headlight glass 9 into the interior 10 of the vehicle headlight 3. In the interior of the vehicle headlight 3, the reflected light typically arrives directly at the detection unit 17. The detection unit 17 may typically receive, via a line 13, information on the light emitted by the LEDs 13L and optionally on the pulsing of the light. The detection unit 17 may further process the received analog light information of the reflected light.

The detection unit 17 may be connected to an interface 18 via a line 17A. The interface 18 may comprise a CAN interface or some other interface typical of motor vehicles, so that the signals provided by the detection unit 17 can be subjected to further processing.

FIG. 4 shows a scheme of a system for monitoring road conditions, comprising a vehicle 1 as described with reference to FIG. 1, the vehicle comprising at least one vehicle headlight 3 as described with reference to FIG. 2, and the vehicle headlight 3 comprising a device as described with reference to FIG. 3. FIG. 4 additionally shows that, in the system, the vehicle may be connected via a wireless connection 30 to an internet server 31 through which the roadway surface analyses received from the vehicle can be subjected to further processing. The internet server 30 may be connected via a connection 31L to a data store 33, e.g. a data cloud, in which the information from the internet server can be stored. In addition, the information stored in the data store 33 can be accessed by means of a control computer 35 via a connection 33L and this information can be made available to a plurality of drivers of vehicles or vehicle steering systems. Alternatively and additionally, the vehicle may be connected via the wireless connection 30 to at least one further vehicle for data transfer/exchange. The information/data on the roadway surfaces may be acquired making use of the device described with reference to FIG. 3 and may then be transmitted to the other vehicle via the wireless connection 30.

1. A vehicle headlight comprising:
a lighting unit, a reflector and a headlight glass;
a device for determining road conditions, said device being provided in the interior of the vehicle headlight behind the headlight glass and comprising:
an infrared transmitter configured for emitting light at predetermined wavelengths through the headlight glass onto a road surface;
a detection unit configured for detecting the light emitted by the infrared transmitter and reflected by the road surface through the headlight glass;
a processing unit configured for determining surface parameters of the road surface on the basis of the light detected by the detection unit.

2. The vehicle headlight according to claim 1, wherein the device is attached directly to the inner side of the headlight glass.

3. The vehicle headlight according to claim 1, wherein the device is replaceable.

4. The vehicle headlight according to claim 1, wherein the processing unit is configured for determining the surface parameters of the road surface at least 100 times per second, in particular at least 400 times per second.

5. The vehicle headlight according to claim 1, wherein the device additionally comprises a pulse unit configured for pulsing the light emitted by the infrared transmitter such that the resultant pulses have a maximum duration of 500 μs, in particular a maximum duration of 100 μs, and/or no-pulse periods of maximum 500 μs, in particular of maximum 100 μs.

6. The vehicle headlight according to claim 1, wherein, in said device, the infrared transmitter is configured for transmitting light with at least two predetermined different wavelengths or from at least two predetermined different wavelength regions.

7. The vehicle headlight according to claim 6, wherein each of the different wavelengths lies in the infrared region, wherein the infrared transmitter is additionally able to emit a reference wavelength for the purpose of calibration, wherein the reference wavelength also lies in the infrared region.

8. The vehicle headlight according to claim 1, wherein the surface parameters comprise one or a plurality of parameters for wetness, ice thickness, snow thickness, water film thickness, the ice-to-water ratio, the freezing temperature of an ice-water mixture, the salt content of an ice-water mixture and the coefficient of friction.

9. The vehicle headlight according to claim 1, wherein the device additionally comprises an interface for an exchange of data with the Internet and/or a mobile computer unit and/or a mobile radio unit.

10. The vehicle headlight according to claim 9, wherein the interface may comprise a Bluetooth interface and/or a CAN interface and/or an RS485 interface and/or an interface typical of motor vehicles.

11. A vehicle, in particular a passenger car or a motor truck, comprising at least one vehicle headlight according to claim 1.

12. The vehicle according to claim 11, further comprising a wireless data connection unit configured for transmitting data to another vehicle, and a control unit configured for transmitting data acquired by means of the device for determining road conditions to said other vehicle via the data connection unit.

13. A system for monitoring road conditions, comprising a vehicle according to claim 11 and an internet server connected to the device for determining road conditions for the purpose of an exchange of data and a computer unit connected via the internet server to said device for the purpose of an exchange of data.

14. The vehicle headlight according to claim 4, wherein the device additionally comprises a pulse unit configured for pulsing the light emitted by the infrared transmitter such that the resultant pulses have a maximum duration of 500 μs, in particular a maximum duration of 100 μs, and/or no-pulse periods of maximum 500 μs, in particular of maximum 100 μs.

15. The vehicle headlight according to claim 4, wherein, in said device, the infrared transmitter is configured for transmitting light with at least two predetermined different wavelengths or from at least two predetermined different wavelength regions.

16. The vehicle headlight according to claim 5, wherein, in said device, the infrared transmitter is configured for transmitting light with at least two predetermined different wavelengths or from at least two predetermined different wavelength regions.

17. The vehicle headlight according to claim 15, wherein each of the different wavelengths lies in the infrared region, wherein the infrared transmitter is additionally able to emit a reference wavelength for the purpose of calibration, wherein the reference wavelength also lies in the infrared region.

18. The vehicle headlight according to claim 16, wherein each of the different wavelengths lies in the infrared region, wherein the infrared transmitter is additionally able to emit a reference wavelength for the purpose of calibration, wherein the reference wavelength also lies in the infrared region.

19. A vehicle, in particular a passenger car or a motor truck, comprising at least one vehicle headlight according to claim 4.

20. A vehicle, in particular a passenger car or a motor truck, comprising at least one vehicle headlight according to claim 5.
